(19) United States
(12) Patent Application Publication
(10) Pub. No.: US 2015/0033156 A1
(43) Pub. Date: Jan. 29, 2015

(54) OPPORTUNISTIC USE OF TRANSIENT USER INTERFACE SPACE

(71) Applicant: DECLARATIV, INC., Sunnyvale, CA (US)

(72) Inventor: Benoit Marchant, San Jose, CA (US)

(21) Appl. No.: 14/338,199

(22) Filed: Jul. 22, 2014

Related U.S. Application Data
(60) Provisional application No. 61/858,459, filed on Jul. 25, 2013.

(51) Int. Cl. G06F 3/0484; G06F 9/54; G06F 3/0488

(52) U.S. Cl. CPC G06F 3/0484; G06F 3/0488; G06F 9/54
USPC 715/760

(57) ABSTRACT

Opportunistic display of content in a transiently available display area is disclosed. In various embodiments, an indication to display content in a display area made available in connection with an operation to update a primary application content is received. Content other than primary application content is obtained for and displayed in the display area.

### CROSS REFERENCE TO OTHER APPLICATIONS

This application claims priority to U.S. Provisional Patent Application No. 61/858,459 entitled OPPORTUNISTIC USE OF TRANSIENT USER INTERFACE SPACE filed Jul. 25, 2013 which is incorporated herein by reference for all purposes.

### BACKGROUND OF THE INVENTION

Many mobile applications, especially on iOS® and other mobile devices, utilize a “Rubber Band” effect, in which the content at the top of the screen is pulled away from the top of the viewport, revealing empty (background) space, which is displayed until application content is ready to be occupy the entire screen area. This user interaction may be used, for example, to trigger a refresh of the content displayed in the scrolling area. The user scrolls to the top of the scrolling area, using drag/swipe gestures for example, and once at the top initiates a refresh by performing a touch and drag down gesture to expose a blank area, at least a portion of which typically remains displayed temporarily, for example until refreshed application content has been retrieved from a remote server and is ready to be displayed and/or simply until the user releases the scroll area content and allows it to be pulled back up to the top of the display.

Examples of applications that have used such a feature/interaction include, without limitation, mail applications (to refresh messages as displayed in an inbox or other folder view, for example to retrieve messages received at a remote server subsequent to a last time the content was refreshed); social network applications (e.g., to update a newsfeed or other display of post to reflect more recently-received posts); sports results and other news feeds (e.g., to update the baseball game score while in progress); and search results.

Users may perform such refresh interactions very frequently, and often can be observed to look at the mobile device display while waiting for the application content to be refreshed.

### BRIEF DESCRIPTION OF THE DRAWINGS

Various embodiments of the invention are disclosed in the following detailed description and the accompanying drawings.

FIG. 1 is a flow chart illustrating an embodiment of a process to display content in transient user interface space.

FIG. 2 is a flow chart illustrating an embodiment of a process to create transient user interface space.

FIG. 3A is a block diagram illustrating an example of transient user interface space.

FIG. 3B is a block diagram illustrating an example of displaying content transient user interface space.

FIG. 4 is a flow chart illustrating an embodiment of a process to include in a mobile application software code to create and opportunistically display content in transient user interface space.

FIG. 5 is a flow chart illustrating an embodiment of a process to download and cache content to be displayed in transient user interface space.

FIG. 6 is a flow chart illustrating an embodiment of a process to display content in transient user interface space.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Opportunistic display of content in transient user interface display space is disclosed. In various embodiments, transient user interface display space may be made available as a result of user input, such as the touch and drag down gesture sometimes used to refresh mobile (or other touch device) app content, or otherwise. Content is obtained and displayed opportunistically in such temporarily available display space. For example, advertising content, an animation, and/or interactive content such as an interactive ad, interactive game, or interactive animation, may be displayed.

In various embodiments, temporarily displayed otherwise unused space that may be revealed, for example, by pulling the scroll list down from the top is used to show external content, such as when this gesture is used to refresh content. The content returned, which could be advertising or other content, in various embodiments is sent dynamically from a back-end server. In various embodiments, external content may be retrieved each time from a remote server, or at least some content may be downloaded to the mobile device in advance, and cached at the mobile device (e.g., for a configured time), to be ready to be displayed opportunistically as opportunities arise. In various embodiments, new content is displayed each time the user pulls down.

The size and duration of the content displayed in various embodiments may be fine-tuned and/or determined dynamically: In some embodiments, the developer of the application in use may have made choices communicated to a back-end server, and such choices or a default will be used by the back-end server to decide what content to return. Such content in some embodiments would have an intrinsic size or ratio that may be taken into account by the client to display it. Such content would in some embodiments have a property indicating how long it should display at the minimum, and the client scrolling control would leverage that defined duration to adjust its behavior. In some embodiments, a standard size of opportunistically-display content is or may optionally be used, e.g., to simplify distributing third party content in this space.

In some embodiments, opportunistically displayed content may comprise an image and/or a mini application, for example and without limitation, a Montage or other HTML5 application, which offers a rich experience. The Montage Scroller and/or List components may be used in various embodiments to implement this behavior.

In some embodiments, user engagement with the opportunistically displayed content may extend the time the opportunistically displayed content is displayed. After a prescribed time and/or on occurrence of a prescribed event or condition, the opportunistically displayed content is no longer displayed. For example, in some embodiments an advertiser may pay a higher fee to have advertising content displayed for a longer time. In some embodiments, opportunistically displayed content may be displayed for at least a prescribed minimum time, and/or until the mobile app is ready to display refreshed or otherwise updated app content.

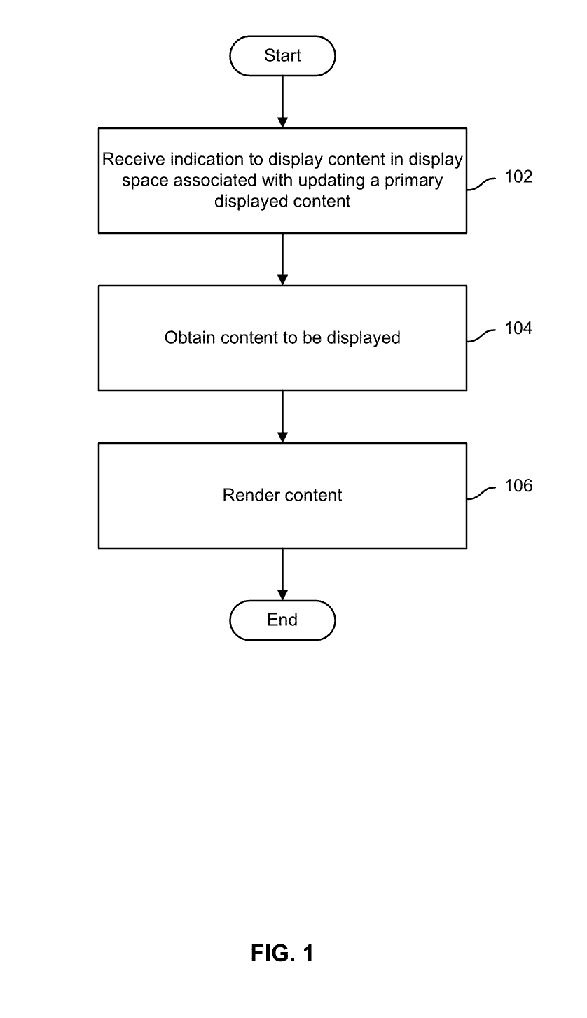

FIG. 1 is a flow chart illustrating an embodiment of a process to display content in transient user interface space. In various embodiments, the process of FIG. 1 may be implemented by code included in and/or otherwise associated with a mobile or other application. In the example shown, an indication is received to display content in display space associated with updating a primary displayed content (102). For example, a user input on a touch display, such as a multi-touch mobile phone display device, may be received and determined to be associated with a user gesture to update mobile app or other primary content, such as the touch and drag down gesture associated with “rubberband” effect and input to refresh content. In some embodiments, the indication may be received by code comprising or otherwise associated with a user interface controller and/or other object configured to detect and recognize the user gesture or other input as being associated with a user request to refresh content. In the example shown, content to be displayed is obtained (104). In some embodiments, content may be obtained dynamically at refresh/display update time, e.g., by making a call to a backend server configured to provide content to be displayed opportunistically at the device. In some embodiments, content may be cached at the device and obtained in step 104 from the local cache, if available. In various embodiments, the content may be determined at least in part based on one or more content selection criteria, such as one or more of a mobile or other application context with which the indication received at step 102 is associated (e.g., ads or other content considered to be relevant to the mobile or other primary app, the primary app content being displayed, a demographic or other user attribute associated with the app, etc.); a demographic or other user attribute (e.g., a programmatically-determined preference, interest, or other affinity; a preference or interest explicitly indicated by the user; etc.); the current geographical location of the user and results of an advertising or other content matching algorithm, process, and/or service. The obtained content is rendered in the display area made available as a result of the user input (106), e.g., the display space (typically) at the top of the display in which either no content or an operating system provided pull-to-refresh animation would otherwise be displayed.

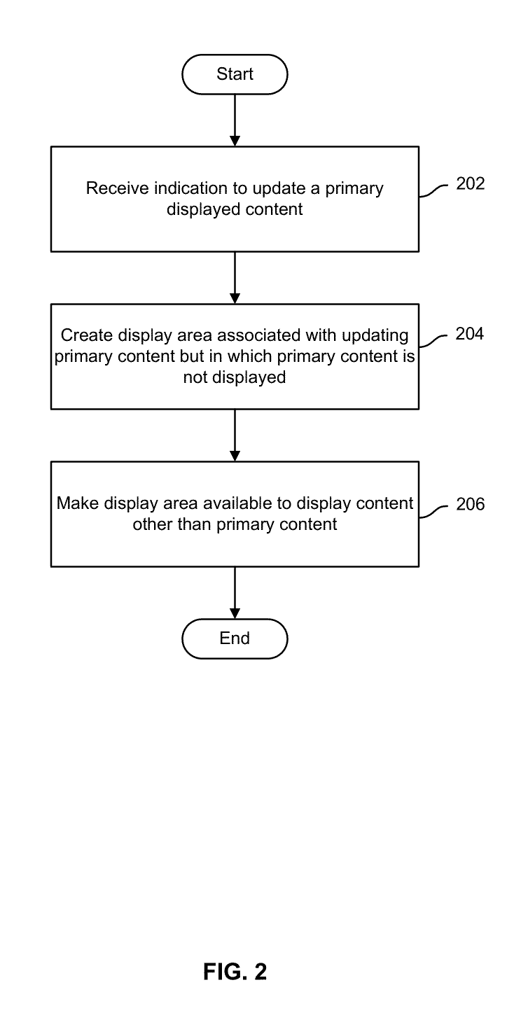

FIG. 2 is a flow chart illustrating an embodiment of a process to create transient user interface space. In various embodiments, the process of FIG. 2 may be implemented by code included in, invoked by, and/or otherwise associated with a mobile or other application. For example, in some embodiments, the process of FIG. 2 may be performed by a user interface object or other user interface code, and/or by an object, process, service, or other code associated with a user interface object or other user interface code. In the example shown, an indication is received to update a primary displayed content (202). For example, in an iOS or other mobile device, a touch and pull down gesture may have been performed by a user and interpreted by the device to be associated with a pull-to-refresh input. In response, a display area associated with updating the primary content, but in which primary content is not (currently) displayed, is created (204). For example, in some embodiments, the primary content to be refreshed is displayed in a lower portion of the screen and space is created at the top of the screen. The display space that has been created is made available to be used to display content other than the primary (e.g., mobile app) content (206). In some embodiments, the display space is made available by generating an event, message, or other notification to an object, service, and/or other code or entity configured to implement the process of FIG. 1 (e.g., 102 of FIG. 1).

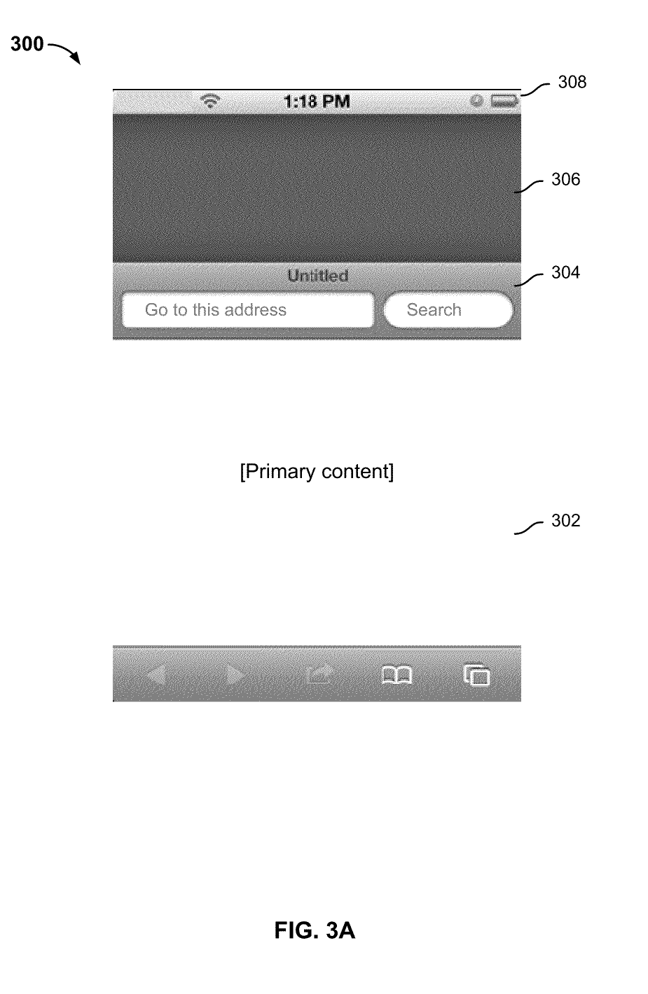

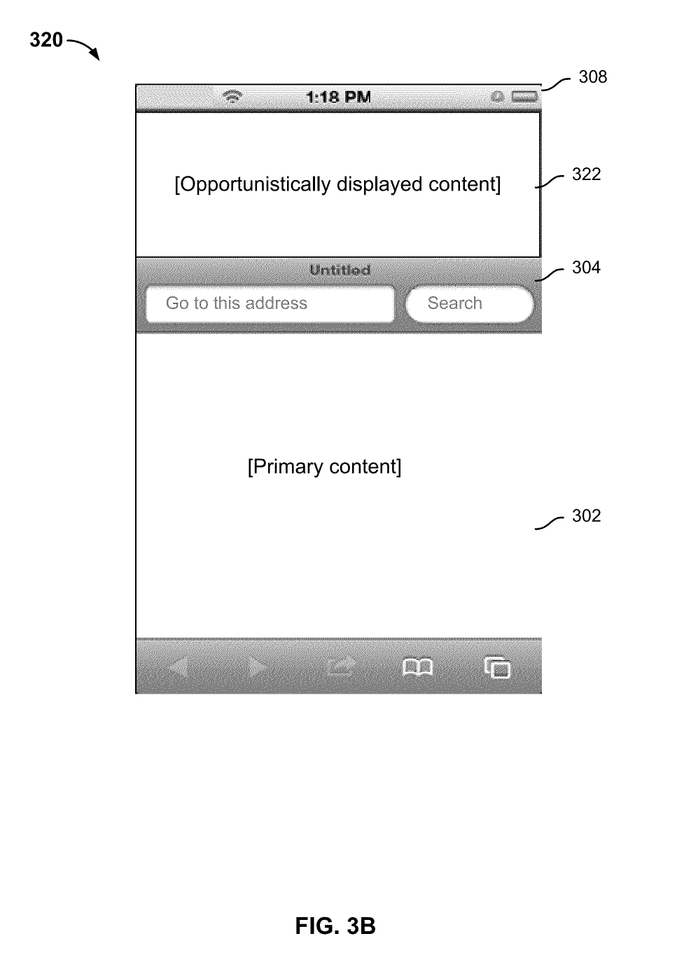

FIG. 3A is a block diagram illustrating an example of transient user interface space. In the example shown, the display 300 includes a primary content display area 302 in which primary (e.g., mobile app) content that is to be refreshed is displayed. An address/search bar 304 is displayed immediately above the primary content display area 302. A transient user interface space 306 is defined between the address/search bar 304 and a mobile (or other) device information/status bar 308 displayed at the top of display 300.

FIG. 3B is a block diagram illustrating an example of displaying content transient user interface space. In the example shown in FIG. 3B, opportunistically-displayed content 322 is displayed in the portion of display 320 that has been provided between the address/search bar 304 and a mobile (or other) device information/status bar 308.

While in the examples shown in FIGS. 3A and 3B the transient user interface space that is made available is provide near the top of the display (e.g., 306, 322), in various embodiments display space may be made available and used to display opportunistically-displayed content at any location on the screen, including by way of example and without limitation, near the bottom, at the sides, and by ghosting out or otherwise partly obscuring or otherwise minimizing the primary content and overlaying the display area over the primary content.

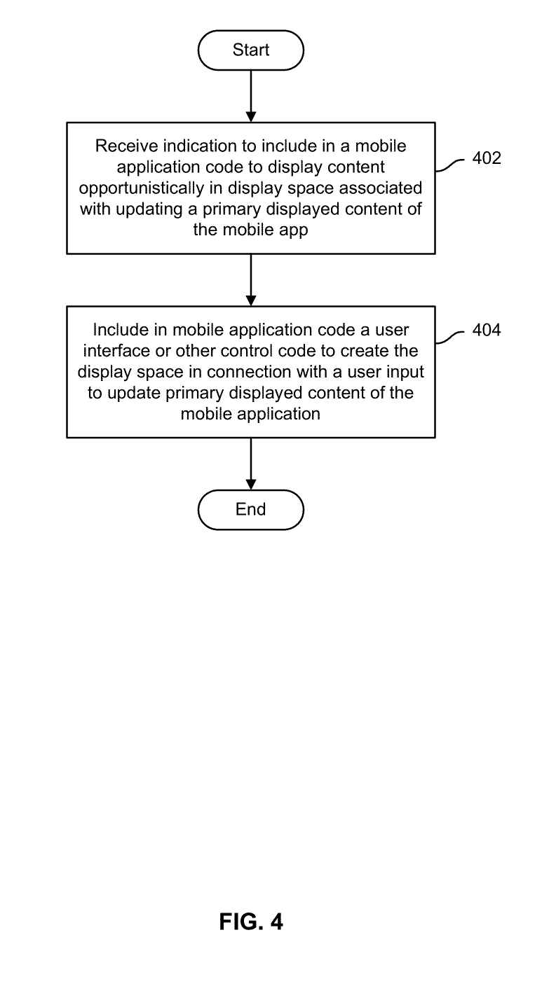

FIG. 4 is a flow chart illustrating an embodiment of a process to include in a mobile application software code to create and opportunistically display content in transient user interface space. In various embodiments, the process of FIG. 4 may be implemented by a software development tool, such as a software development kit (SDK) or other tool. In the example shown, an indication is received to include in a mobile application code to display content opportunistically in display space associated with updating a primary displayed content of the mobile application (402). For example, a development tool may provide an interface to enable a developer to include in the application code of the mobile application a capability to enable a user to “pull-to-refresh” or provide other user input to refresh the primary content, and to display content other than primary content of the mobile application opportunistically upon receipt of such indication, e.g., in a display area created in connection with the operation to refresh the primary content (see, e.g., 306 of FIG. 3A and 322 of FIG. 3B). A user interface and/or other code to create such a display space in connection with a refresh operation and display in the created space content other than primary content of the application is included in (or otherwise associated with) the mobile application (404).

In some embodiments, code to obtain and display opportunistically displayed content may be included by providing developers one or more specialized user interface (UI) controls configured to display opportunistically displayed content. In some embodiments, developers would use such specialized UI controls in the source code of the mobile (or other) application they are developing. Such specialized UI controls to display opportunistic content may be made available, in various embodiments, by the operating system/device vendor. In various embodiments, specialized UI controls may be integrated, or not, by default in List and ScrollView type widgets.

Starting with the “iOS6” mobile operating system provided by Apple Inc.®, for example, the UITableViewController (a controller object) has a property called “refreshControl” that expects a UIRefreshControl object, as described, for example, at the following URL: http://developer.apple.com/library/ios/#documentation/uikit/reference/UIRefreshControl_class/R eference/Reference.html#//apple_ref/doc/c_ref/UIRefreshControl. In some embodiments, an “OpportunisticContentRefreshControl” is provided, with an API that is based on and/or otherwise compatible with the operating system-provided UIRefreshControl object, and which may be used as a direct substitute for the operating system's UIRefreshControl object to show opportunistically displayed content instead of UIRefreshControl's pre-defined pull-to-refresh animation. That is, in some embodiments, instead of displaying the conventional pull-to-refresh animation, the OpportunisticContentRefreshControl object includes methods to obtain and display opportunistically-displayed content in the display space created at the top of the display area, as disclosed here, e.g., while updated primary app content is being obtained and/or readied to be displayed.

In some embodiments, an “OpportunisticContentRefreshControl may be inserted as a direct subview of a UIScrollView to deliver the same feature.

On Android and other mobile operating systems and/or devices, similar substitutes are provided in various embodiments for Lists, ScrollViews, and/or other UI controls offering similar behavior.

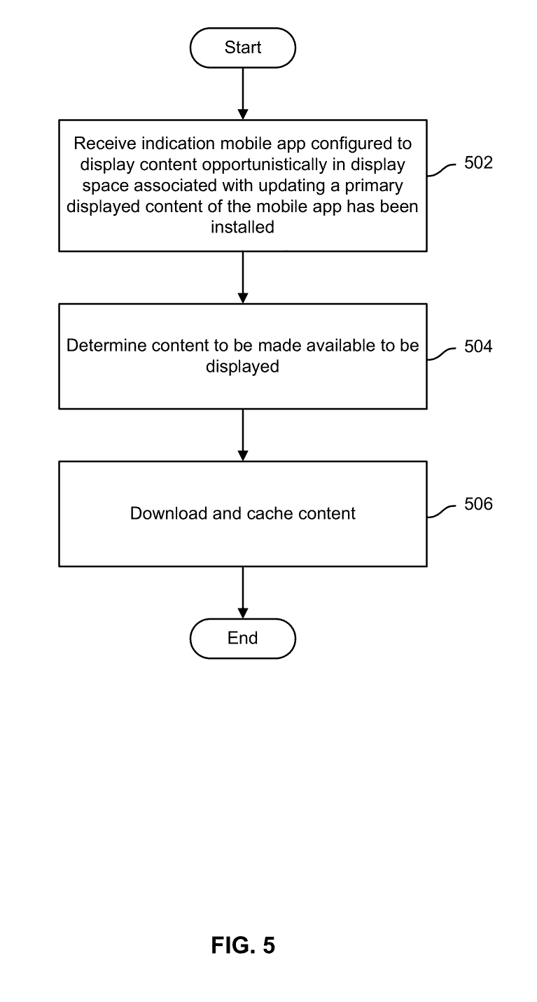

FIG. 5 is a flow chart illustrating an embodiment of a process to download and cache content to be displayed in transient user interface space. In various embodiments, the process of FIG. 5 may be performed by a mobile application or other code configured to obtain and cache content to be displayed opportunistically as disclosed herein, e.g., during and/or otherwise in connection with an operation to refresh the primary content of a mobile application. In some embodiments, the process of FIG. 5 may be implemented by the operating system, a trusted agent, a remote or local service, and/or an installed application provided to obtain and cache content. In the example shown, an indication is received that mobile application configured to display content opportunistically in display space associated with updating a primary content of the mobile application has been installed (502). For example, a mobile application that has a substitute UI control code installed may be detected. In some embodiments, metadata associated with the application may identify the application as one configured to display content opportunistically in display space associated with updating a primary content of the mobile application.

Content that is to be displayed opportunistically in connection with use of the mobile application, e.g., during operations to refresh primary content of the mobile application, is determined (504). For example, in some embodiments an application developer may embed in the application code of the mobile application, and/or in associated metadata, data values indicating a category or type of information with which the mobile application is associated and/or specific categories or types of content the developer associates with the mobile application and/or users thereof. For example, a developer of a “first party shooter” game may include data indicating demographic and/or other attributes typically associated with users of such a game. In some embodiments, standard advertising, business classification, and/or other codes may be used. In some embodiments, user attribute associated with a user of the mobile application and/or the device may be used to determine content to be obtained. For example, a user profile built by observing user behavior and/or based on explicit user input may be used to determine content to be obtained. In some embodiments, content to be obtained may be determined at least in part dynamically, e.g., based on mobile application state, primary content, environmental, and/or other internal and/or external information. In some embodiments, browser and/or other tracking information associated with the device and/or a user thereof may be used, e.g., dynamically, to determine content to be obtained.

The content that is determined to be obtained is downloaded and cached (506). The cached content in various embodiments is made available to be displayed opportunistically in connection with use of the mobile application. In various embodiments, cache policies are provided to ensure the cached content remains fresh and available to be displayed opportunistically as disclosed herein. In some embodiments, cached content may be made available to be displayed opportunistically during times when the device is offline (i.e., no Internet access) and/or has a slow connection.

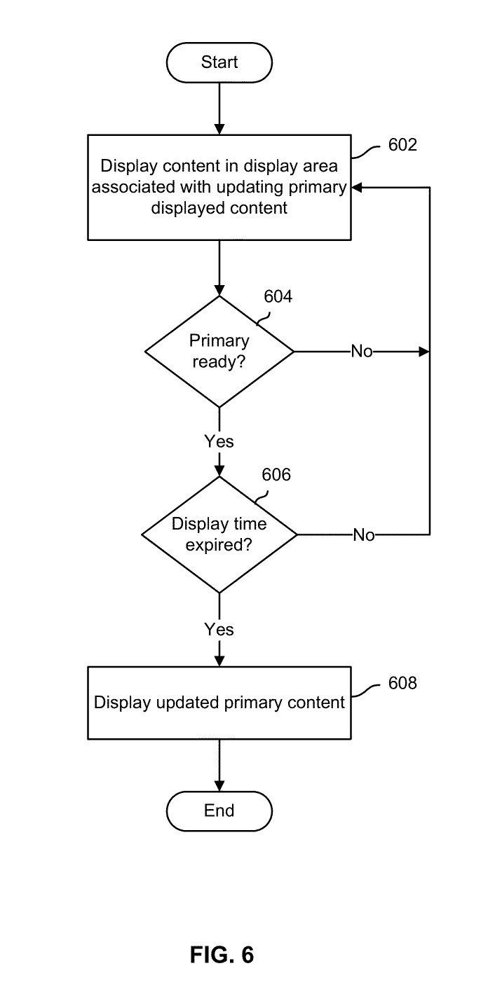

FIG. 6 is a flow chart illustrating an embodiment of a process to display content in transient user interface space. In the example shown, non-primary content is displayed in a display area associated with updating a primary displayed content, e.g., a primary content of a mobile application (602). Once updated/refreshed primary content is ready to be displayed (604), in this example it is determined whether a minimum/prescribed display time to display the opportunistically-displayed content has expired (606). For example, in some embodiments, a minimum display time may be indicated by a developer of the mobile application, a carrier or other vendor or provider, etc. In some embodiments, advertisers may bid or other indicate a willingness to pay varying amounts determined based at least in part on the length of time for which an ad or other non-primary content is to be displayed opportunistically. In some embodiments, the display time may vary based on factors such as primary mobile application state, user identity, and/or user input. In some embodiments, a user may be provided an interface to dismiss the opportunistically-displayed content prior to expiration of the time period, for example an “x” or other control.

In some embodiments, user engagement with the opportunistically-displayed content may extend the display time. For example, in the case of an advertisement, user expression of interest in the ad may result in associate content being rendered and interacted with, in some embodiments in a window, overlay, or other user interface and/or display provided without leaving the context of the primary mobile application. Upon completion of user interaction with the opportunistically-displayed content (and/or other content and/or functionality associated therewith), refreshed primary content may be displayed. Similarly, in some embodiments, user interaction with opportunistically-displayed content such as an interactive animation (for example, similar to a Google® “doodle”) or game may extend the period of display of opportunistically-displayed content.

Once the prescribed time to display the opportunistically-displayed content has passed (606), the updated primary content is displayed, e.g., in the full display area (608).

Using techniques described herein, advertisements, applications, and other content may be displayed opportunistically to users as they wait for application content to be refreshed.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of displaying content, comprising:
receiving an indication to display content in a display area made available in connection with an operation to update a primary application content;
obtaining for display in the display area content other than primary application content; and
displaying the obtained content in the display area.

2. The method of claim 1, further comprising receiving an indication to perform the operation to update the primary application content.

3. The method of claim 2, wherein the indication to perform the operation comprises a user input.

4. The method of claim 3, wherein the user input comprises a pull-to-refresh gesture entered via a touch display interface.

5. The method of claim 1, further comprising receiving an indication that an updated primary application content is available to be displayed; and discontinuing display of the obtained content based at least in part on the indication that the updated primary application content is available to be displayed.

6. The method of claim 5, further comprising continuing to display the obtained content for a prescribed period.

7. The method of claim 6, wherein the prescribed period is determined by a developer of the primary application.

8. The method of claim 6, wherein the prescribed period is determined at least in part based on a fee paid in connection with display of the obtained content.

9. The method of claim 1, wherein the displayed content comprises an advertisement.

10. The method of claim 1, wherein the displayed content comprises interactive content.

11. The method of claim 10, wherein a display period of the displayed content is extended based at least in part on a determination that a user has engaged with the interactive content.

12. The method of claim 10, wherein the interactive content comprises one or more of the following: an interactive ad, a game, and an interactive animation.

13. The method of claim 1, wherein the obtained content is obtained and cached at a download time prior to said indication to display content being received.

14. The method of claim 1, wherein the indication to display content comprises a user input associated with the operation to update primary application content and said steps of obtaining and displaying content are performed at least in part by a user interface code associated with the operation to update primary application content.

15. The method of claim 14, wherein said user interface code associated with the operation to update primary application content is configured to create said display area made available in connection with the operation to update the primary application content.

16. A system, comprising:
a display device; and
a processor coupled to the display device and configured to:
receiving an indication to display content in a display area of the display device made available in connection with an operation to update a primary application content;
obtaining for display in the display area content other than primary application content; and
displaying the obtained content in the display area.

17. The system of claim 16, wherein the processor is further configured to receive an indication to perform the operation, the indication comprising a user input entered via the display device.

18. The system of claim 16, wherein the processor is further configured to receive an indication that an updated primary application content is available to be displayed; and to discontinue display of the obtained content based at least in part on the indication that the updated primary application content is available to be displayed.

19. The system of claim 16, wherein the processor is further configured to extend a display period of the displayed content based at least in part on a determination that a user has engaged with the interactive content.

20. A computer program product to display content, the computer program product being embodied in a non-transitory computer readable medium, and comprising computer instructions for:
receiving an indication to display content in a display area made available in connection with an operation to update a primary application content;
obtaining for display in the display area content other than primary application content; and
displaying the obtained content in the display area.
